(19) United States
(12) Patent Application Publication
(10) Pub. No.: US 2026/0046462 A1
(43) Pub. Date: Feb. 12, 2026

(54) METHODS, APPARATUS AND SYSTEMS FOR ISOBMFF FILE ENHANCED GROUPING OF TRACKS

(71) Applicant: DOLBY INTERNATIONAL AB, Dublin (IE)

(72) Inventors: Stephan SCHREINER, Birgland (DE); Wolfgang A. SCHILDBACH, Nuremberg (DE)

(73) Assignee: DOLBY INTERNATIONAL AB, Dublin (IE)

(21) Appl. No.: 19/100,453

(22) PCT Filed: Aug. 1, 2023
(86) PCT No.: PCT/EP2023/071305

§ 371 Date: Jan. 31, 2025

Related U.S. Application Data
(60) Provisional application No. 63/394,027, filed on Aug. 1, 2022.
(60) Provisional application No. 63/417,426, filed on Oct. 19, 2022.

(51) Int. Cl. H04N 21/235; H04N 21/2343; H04N 21/2365; H04N 21/262; H04N 21/845; H04N 21/854

(52) U.S. Cl. CPC H04N 21/235; H04N 21/2343; H04N 21/2365; H04N 21/26258; H04N 21/8456; H04N 21/85406

(57) ABSTRACT

Described herein is a method of processing media streams. The method includes: receiving one or more media streams and side information for the one or more media streams, the one or more media streams comprising media content comprising one or more tracks; generating an ISO Base Media File Format, ISOBMFF, file based on the one or more media streams and the side information; and outputting the generated ISOBMFF file for further processing. Further described are a respective method of processing an ISOBMFF file, respective apparatuses and a computer program product.

### CROSS-REFERENCE TO RELATED APPLICATION

This application claims priority of the U.S. Provisional Application No. 63/394,027 filed Aug. 1, 2022, and U.S. Provisional Application No. 63/417,426 filed on Oct. 19, 2022, both of which are incorporated herein by reference in their entirety.

### TECHNICAL FIELD

The present disclosure relates generally to a method of processing media streams. The method includes, in particular, generating an ISO Base Media File Format, ISOBMFF, file based on one or more media streams and side information. The present disclosure relates further to a method of processing an ISOBMFF file, to respective apparatuses and computer program products.

While some embodiments will be described herein with particular reference to that disclosure, it will be appreciated that the present disclosure is not limited to such a field of use and is applicable in broader contexts.

### BACKGROUND

Any discussion of the background art throughout the disclosure should in no way be considered as an admission that such art is widely known or forms part of common general knowledge in the field.

Modern video compression schemes may generally utilize the possibility to span the overall available media data over several streams for different reasons including the possibility to save transmission bandwidth.

For streaming applications one media asset may be encoded into streams using different bitrates. This set of streams-called “Representations” in Dynamic Adaptive Streaming over HTTP (DASH) as defined in ISO/IEC 23009 by the Motion Pictures Expert Group (MPEG) MPEG DASH, “CMAF tracks” in the Common Media Application Format for Segmented

Media (CMAF) as specified in ISO/IEC 23000-19 by MPEG—are grouped to allow to dynamically switch between these streams to react to changing network conditions. The grouping is called “AdaptationSet” in DASH, “Switching Set” in CMAF.

The International Organization for Standardization (ISO) includes and specifies a Base Media File format, generally known as ISOBMFF. In particular, this ISOBMFF is specified by ISO/IEC 14496-12 MPEG-4 Part 12 by the ISO. Generally speaking, ISOBMFF is a container file format that defines a general structure for time-based multimedia files such as video and/or audio.

In a typical setup, a group of one or more encoders would encode the input signal(s) into tracks at different bitrates. Additionally, if there are several variations of the input signal (varying for example in the spoken language or through the addition of spoken subtitles), several groups of these encoder groups would run in parallel to create the variations in all required bitrates. In presently typical implementations, the encoders would each output an ISOBMFF with one ISOBMFF track.

ISOBMFF tracks can be grouped using derivatives of TrackGroupTypeBoxes as defined in ISO/IEC 14496-12 MPEG-4 Part 12 section 8.3.4. The type of grouping is specified by a track_group_type identifier. By choosing different track_group_type identifiers, different types of groupings with different semantics can be defined.

To define a group of tracks, rather than listing all grouped tracks in a list in the TrackGroupTypeBox, the grouping is achieved by implicit building of equivalence classes. All tracks that are part of a specific group carry a TrackGroupTypeBox with same type and id identifiers. In other words, if and only if two tracks contain such derivatives of the TrackGroupTypeBox with same type and id identifiers, both tracks belong to the same group.

A first mechanism to collate properties of track groups is currently under development in MPEG: The TrackGroupDescriptionBox acts as a container for TrackGroupEntryBox and its derivatives.

A second mechanism in ISOBMFF to group tracks uses derivatives of Entity ToGroupBoxes as defined in ISO/IEC 14496-12 MPEG-4 Part 12 section 8.18.3. The type of grouping is specified by a grouping_type identifier. By choosing different grouping_type identifiers, different types of groupings with different semantics can be defined.

A group of tracks (e.g., tracks using the entity grouping mechanism) may use an instance of the Entity ToGroupBox to reference all tracks through their respective track_ids.

A third mechanism in ISOBMFF for grouping tracks uses the alternate_group field in the track header box as defined in ISO/IEC 14496-12 MPEG-4 Part 12 section 8.3.2. No grouping type is available for this type of grouping. The grouping is achieved by assigning identical identifiers to the alternate_group field of all tracks of the group, where an identifier of ‘0’ implies that a respective track does not belong to any group.

Further, to prepare the ISOBMFF tracks for segmented transmission, each of these tracks would be acted upon by a segmenter which breaks the tracks into streams of short duration segments, each segment typically representing a few seconds. Finally, a DASH manifest generator describes the configuration of the segmented streams in a manifest file. The manifest file then contains a high level description of the various streams (i.e., language, accessibility properties, bitrate and so on) and there interrelations.

There is, however, still an existing need for further derivatives to allow signaling dependencies between groups of tracks.

### SUMMARY

In accordance with a first aspect of the present disclosure there is provided a method of processing media streams. The method may include receiving one or more media streams and side information for the one or more media streams, the one or more media streams comprising media content comprising (e.g., divided into) one or more tracks. The method may further include generating an ISO Base Media File Format, ISOBMFF, file based on the one or more media streams and the side information. And the method may include outputting the generated ISOBMFF file for further processing. Notably, the side information used for generating the ISOBMFF file is not output for further processing.

Configured as above, the method allows to keep all tracks of media streams, for example, with different bitrates originating from respective encoding processes, in one single ISOBMFF file to thus signal dependencies not only between tracks, but also between groups of tracks. On the other hand, the side information in this framework is not required by downstream devices

In some embodiments, the side information may be indicative of interrelations between some or all of the one or more tracks.

In some embodiments, generating the ISOBMFF file may include grouping some or all of the one or more tracks into one or more track groups.

In some embodiments, the one or more track groups may correspond to one or more DASH AdaptationSets, the one or more tracks within each track group may correspond to one or more DASH Representations within the DASH AdaptationSet.

In some embodiments, the one or more track groups may correspond to one or more DASH AdaptationSets with the potentiality of switching playback from an identified source DASH AdaptationSet to a set of destination DASH AdaptationSets.

In some embodiments, the one or more track groups may correspond to one or more CMAF switching sets, the one or more tracks within each track group may correspond to one or more CMAF tracks within the CMAF switching set.

In some embodiments, the ISOBMFF file may include, for each of the one or more tracks within a track group, a track group type specific box indicating the predefined and specific track group type and a track group identifier, wherein tracks characterized with a same track group type and track group identifier may belong to a same track group, the track group type specific box being included in an ISOBMFF track group box.

In some embodiments, the ISOBMFF file may include, for each of the one or more tracks within a track group, a grouping type specific box indicating the predefined and specific grouping type and a group identifier, wherein a grouping type specific box may be included in an ISOBMFF group list box.

In some embodiments, the ISOBMFF file may further include, for each of the switching potentialities, a track group entry box of predefined type, with its track group identifier being equal to the track group identifier of the track group identifying the source DASH AdaptationSet and a list of track group identifiers equal to those track group identifiers of the track groups identifying the destination DASH AdaptationSets.

In some embodiments, generating the ISOBMFF file may further include grouping the one or more track groups into one or more groups of track groups based on the side information.

In some embodiments, each group of track groups may be indicative of an interrelation between the one or more track groups within the group of track groups.

In some embodiments, the one or more groups of track groups may correspond to one or more CMAF selection sets.

In some embodiments, the one or more groups of track groups may correspond to one or more CMAF aligned switching sets.

In some embodiments, the ISOBMFF file may further include, for each of the one or more groups of track groups, a group of track groups specific box including a list of references to track groups belonging to said group of track groups.

In some embodiments, each of the one or more group of track group specific boxes may be instantiated by a predefined track group entry type of a track group entry box included in an ISOBMFF track group description box.

In some embodiments, each of the one or more group of track group specific boxes may indicate their individual track group identifier, the track group identifier enabling referencing the group of track groups as track group.

In some embodiments, the side information may not be output alongside the ISOBMFF file for further processing.

In accordance with a second aspect of the present disclosure there is provided a method of processing an ISO Base Media File Format, ISOBMFF, file. The method may include receiving an ISOBMFF file including one or more tracks of media content and one or more boxes characterizing interrelations between some or all of the one or more tracks. The method may further include extracting information on each interrelation between the some or all of the one or more tracks from the one or more boxes. The method may further include segmenting the ISOBMFF file based on the extracted information to obtain a plurality of segments. And the method may include outputting the plurality of segments.

In some embodiments, the interrelations may be indicated by one or more track group boxes, grouping one or more tracks into a track group corresponding to a respective interrelation.

In some embodiments, the track group may correspond to a DASH Adaptation Set, the one or more tracks within the track group corresponding to one or more DASH Representations within the DASH AdaptationSet.

In some embodiments, the track group may correspond to a DASH AdaptationSet with the potentiality of switching playback from an identified source DASH AdaptationSet to a set of destination DASH AdaptationSets.

In some embodiments, the track group may correspond to a CMAF switching set, the one or more tracks within the track group corresponding to one or more CMAF tracks within the CMAF switching set.

In some embodiments, for each of the one or more tracks within a track group, the respective interrelation may be indicated by a track group type specific box indicating the predefined and specific track group type and a track group identifier, wherein tracks characterized with a same track group type and track group identifier may belong to a same track group, the track group type specific box being included in an ISOBMFF track group box.

In some embodiments, for each of the one or more tracks within a track group, the respective interrelation may be indicated by a grouping type specific box indicating the predefined and specific grouping type and a group identifier. The grouping type specific box may be included in an ISOBMFF group list box.

In some embodiments, for each of the switching potentialities, the respective interrelation may further be indicated by a track group entry box of predefined type, with its track group identifier being equal to the track group identifier of the track group identifying the source DASH AdaptationSet and a list of track group identifiers equal to those track group identifiers of the track groups identifying the destination DASH AdaptationSets.

In some embodiments, the interrelations may further be indicated by grouping of the one or more track groups into one or more groups of track groups.

In some embodiments, each group of track groups may be indicative of an interrelation between the one or more track groups within the group of track groups.

In some embodiments, the group of track groups may correspond to a CMAF selection set.

In some embodiments, the group of track groups may correspond to a CMAF aligned switching set.

In some embodiments, the interrelations may be indicated by one or more group of track group specific boxes, each including a list of references to track groups belonging to said group of track groups.

In some embodiments, each of the one or more group of track group specific boxes may be instantiated by a predefined track group entry type of a track group entry box included in an ISOBMFF track group description box.

In some embodiments, each of the one or more group of track group specific boxes may indicate its individual track group identifier, the track group identifier enabling referencing the group of track groups as track group.

In some embodiments, the method may further include generating a manifest file based on the ISOBMFF file and outputting the manifest file alongside the plurality of segments.

In some embodiments, the manifest file may include the information on each interrelation between the some or all of the one or more tracks extracted from the one or more boxes.

In some embodiments, the manifest file may be a DASH media presentation description, MPD, file.

In some embodiments, the segmenting the ISOBMFF file may include generating one or more DASH initialization segments, the DASH initialization segments including the information on each interrelation between the some or all of the one or more tracks extracted from the one or more boxes.

In some embodiments, the DASH MPD file may include the information included in the DASH initialization segments.

In some embodiments, the DASH MPD file may include the information on each interrelation between the some or all of the one or more tracks based on the ISOBMFF file, but the DASH initialization segments may exclude the interrelation information.

In accordance with a third aspect of the present disclosure there is provided an apparatus for processing media streams. The apparatus may include one or more processors configured to carry out a method including: receiving one or more media streams and side information for the one or more media streams, the one or more media streams including media content divided into one or more tracks; generating an ISO Base Media File Format, ISOBMFF, file based on the one or more media streams and the side information; and outputting the generated ISOBMFF file for further processing.

In some embodiments, the apparatus may comprise a Multiplexer.

In accordance with a fourth aspect of the present disclosure there is provided an apparatus for processing an ISO Base Media File Format, ISOBMFF, file. The apparatus may include one or more processors configured to carry out a method including: receiving an ISOBMFF file including one or more tracks of media content and one or more boxes characterizing interrelations between some or all of the one or more tracks; extracting information on each interrelation between the some or all of the one or more tracks from the one or more boxes; segmenting the ISOBMFF file based on the extracted information to obtain a plurality of segments; and outputting the plurality of segments.

In some embodiments, the apparatus may comprise a Segmenter.

In some embodiments, the one or more processors may further be configured to generate a manifest file based on the ISOBMFF file and to output the manifest file alongside the plurality of segments.

In some embodiments, the apparatus may further comprise a manifest generator (e.g., a so-called “dasher”).

In accordance with a fifth aspect of the present disclosure there is provided a system of an apparatus for processing media streams as described herein, and an apparatus for processing an ISOBMFF file as described herein.

In accordance with a sixth aspect of the present disclosure there is provided a program comprising instructions that, when executed by a processor, cause the processor to carry out a method of processing media streams and/or a method of processing an ISOBMFF file as described herein.

In accordance with a seventh aspect of the present disclosure there is provided a computer-readable storage medium storing said program.

### BRIEF DESCRIPTION OF THE DRAWINGS

Example embodiments of the disclosure will now be described, by way of example only, with reference to the accompanying drawings in which:

FIG. 1 illustrates a first example of a system of an apparatus for processing media streams and an apparatus for processing ISOBMFF files.

FIG. 2 illustrates an example of a method of processing media streams according to embodiments of this disclosure.

FIG. 3 illustrates an example of a structure of an ISOBMFF file including an enhanced grouping of tracks according to embodiments of this disclosure.

FIG. 4 illustrates a further example of a structure of an ISOBMFF file including an enhanced grouping of tracks according to embodiments of this disclosure.

FIG. 5 illustrates a further example of a structure of an ISOBMFF file including an enhanced grouping of tracks according to embodiments of this disclosure.

FIG. 6 illustrates a further example of a structure of an ISOBMFF file including an enhanced grouping of tracks according to embodiments of this disclosure. FIG. 7 illustrates an example of a method of processing an ISOBMFF file according to embodiments of this disclosure.

FIG. 8 illustrates an example of structures of an ISOBMFF file based initialization segments according to embodiments of this disclosure.

FIG. 9 illustrates a second example of a system of an apparatus for processing media streams and an apparatus for processing an ISOBMFF file according to embodiments of this disclosure.

FIG. 10 illustrates an apparatus including one or more processors and a memory according to embodiments of this disclosure.

### DESCRIPTION OF EXAMPLE EMBODIMENTS

### Overview

When streams with different bitrates originate from respective encoding processes, it is beneficial to keep all tracks in one single ISOBMFF file (or multitrack segment streams). If such a mechanism was defined, it could be used, for example, to represent DASH AdaptationSets and their contained Representations. However, so far no signaling has been defined to group tracks into the abovementioned sets, such that a subsequent streaming packager knows how to separate them to single-track segment streams for internet streaming. CMAF aligned switching sets and selection sets are a concept that makes it necessary to not only group tracks but also to build groups of groups of tracks. While ISOBMFF can already signal dependencies between tracks, it provides no means to signal dependencies between groups of tracks such as those defined in CMAF.

In a typical setup, encoders, segmenters and manifest generators have to be setup to the same configuration using a global controlling instance. These may be implemented in a variety of software environments operating on a variety of hardware platforms. This global configuration creates certain constraints on the deployment of these components which this disclosure addresses by creating, in effect, a data path for this configuration data, in the same ISOBMFF container that also contains the encoded media, making all components standalone.

### First Example of Processing Media Streams and ISOBMFF Files

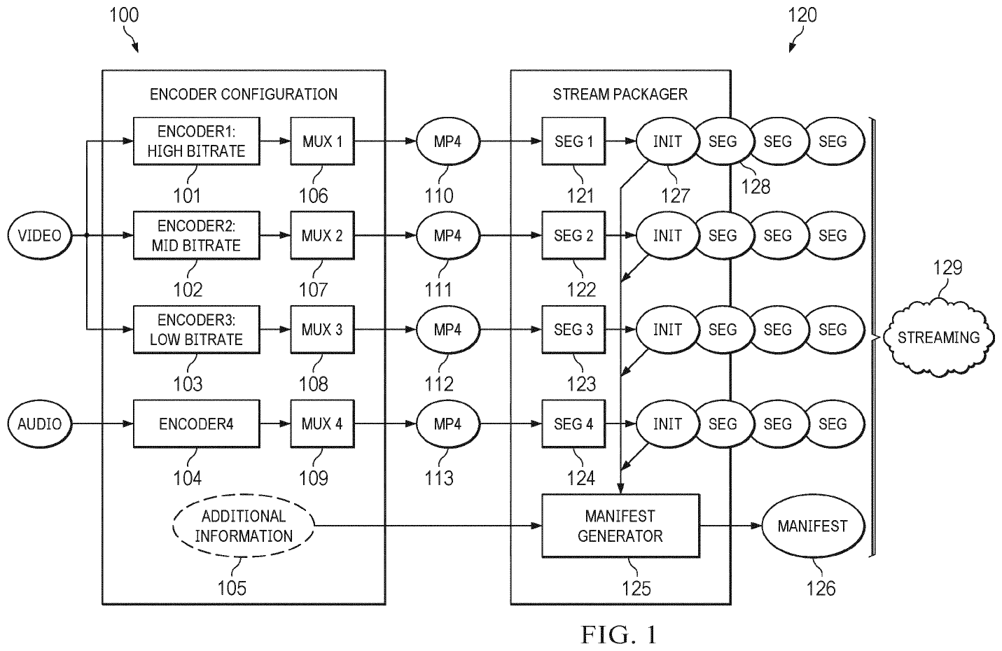

Referring to the example of FIG. 1, a system of an apparatus for processing media streams and an apparatus for processing ISO Base Media File Format, ISOBMFF, files is illustrated.

In this example, at the encoding side, 100, one or more media streams are generated by encoding the same video content at three different bitrates, at a high bitrate in encoder 1, 101, at a middle bitrate in encoder 2, 102, and at a low bitrate in encoder 3, 103. Accompanying audio content is encoded alongside the video content in encoder 4, 104.

The media streams thus generated are then individually processed in respective multiplexers. Mux 1, 106, processes the media stream including one or more tracks of the video content encoded at the high bitrate, Mux 2, 107, processes the media stream including one or more tracks of the video content encoded at the middle bitrate, Mux 3, 108, processes the media stream including one or more tracks of the video content encoded at the low bitrate and Mux 4, 109, processes the media stream including one or more tracks of the audio content. Each multiplexer then outputs, for each of the media streams, a respective individual ISOBMFF file (MP4) 110, 111, 112 and 113. Additional information (side information), 105, indicative of interrelations between some or all of the one or more tracks in the one or more media streams may be output alongside the individual ISOBMFF files for further processing.

In a Stream Packager (streaming packager), 120, the individual ISOBMFF files, 110, 111, 112, 113, are then individually segmented by respective Segmenters, Seg 1, 121; Seg 2, 122; Seg 3, 123 and Seg 4, 124, to generate, based on each of the individual ISOBMFF files, respective initialization segments, 127, and media segments, 128, for streaming. The Stream Packager 120 may be implemented separately or in combination to other components described herein. The initialization segment 127 may contain metadata for presenting a media stream encapsulated in media segments 128 which comply with a media format. These segments 127, 128 may be output for transmission and/or streaming (e.g., over the Internet) 129. For example, the segments may be uploaded to a server, such as an origin server of a content delivery network (CDN).

Referring to MPEG-DASH (ISO/IEC 23009-1) initialization segments and media segments may be described as follows:

Initialization Segment: Segment containing metadata that is necessary to present the media streams encapsulated in Media Segments;

Media Segment: Segment that complies with media format in use and enables playback when combined with zero or more preceding Segments and an Initialization Segment (if any).

In a Manifest Generator, 125, a manifest file, 126, is additionally generated based on the received additional information, 105, and the initialization segments, 127. The manifest file references the metadata for streaming. The manifest file (as specified by MPEG-DASH and also HLS) describes the media presentation; providing the resource identifiers of all segments together with media asset description. The plurality of segments, 127, 128, and the manifest file, 126, are then output for streaming (over the internet), 129. For example, the plurality of segments 127, 128, and the manifest file, 126, may be output to a streaming server or provided to a multicasting server or broadcasting transmitter.

FIG. 1 describes a first example of processing of media streams and ISOBMFF files. Each of the modules in FIG. 1 may be performed in one or more processors, individually or in combination. In this case, individual ISOBMFF files are generated for each of the one or more media streams and output alongside with respective additional information. These individual ISOBMFF files do thus not contain information on the interrelation between tracks as included in the side information.

### Second Example of Processing Media Streams and an ISOBMFF File

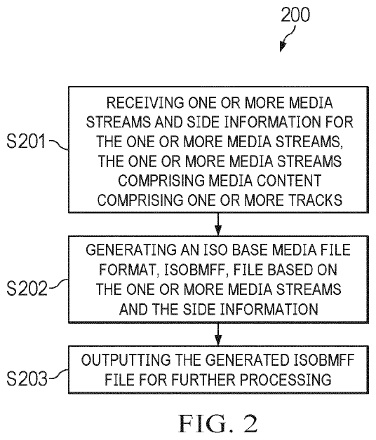

Referring now to the example of FIG. 2, an improved method 200 for processing media streams according to embodiments of this disclosure is illustrated in a flow process chart.

In step S201, one or more media streams and side information for the one or more media streams are received, for example, by a receiver. The receiver may be part of a Multiplexer, for example. The one or more media streams comprise media content comprising (e.g., being divided into) one or more tracks.

In step S202, a (single) ISO Base Media File Format, ISOBMFF, file is generated based on the one or more media streams and the side information. That is, the side information may not be output alongside the ISOBMFF file for further processing as in the example of FIG. 1. Accordingly, in step S203, the generated (single) ISOBMFF file is then output for further processing. The further processing may include processing by a streaming packager (stream packager), for example, to separate the ISOBMFF file into segment streams for internet streaming. For example, ISOBMFF files may be output for archival and/or segmenting for transmission and/or streaming (e.g., over the Internet).

In an embodiment, the side information may be indicative of interrelations between some or all of the one or more tracks. In generating the ISOBMFF file based on the one or more media streams and the side information, this single ISOBMFF file thus includes information about the interrelations between some or all of the one or more tracks as described herein.

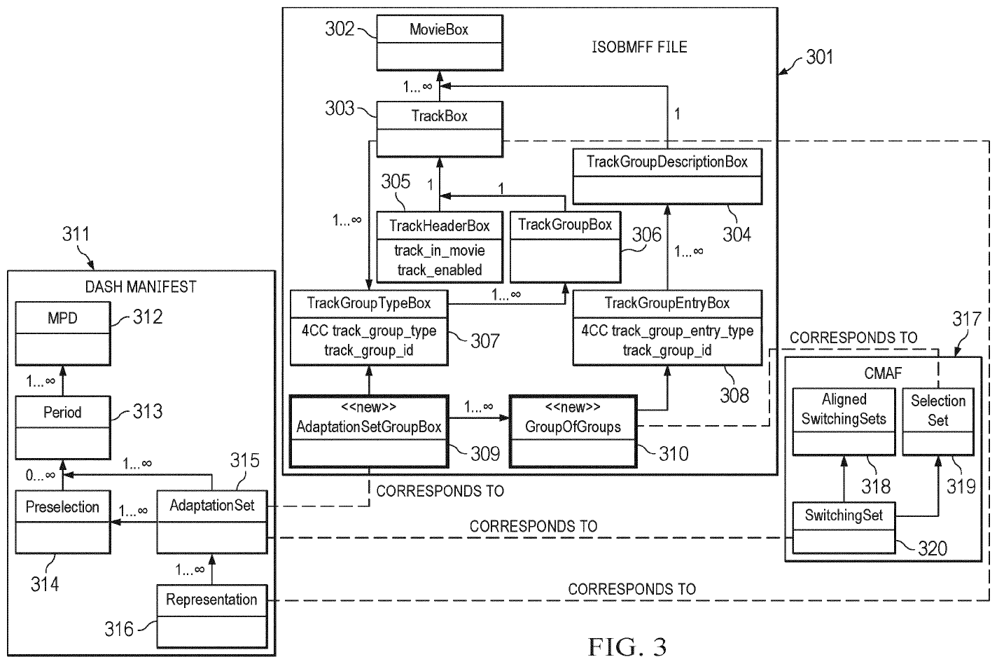

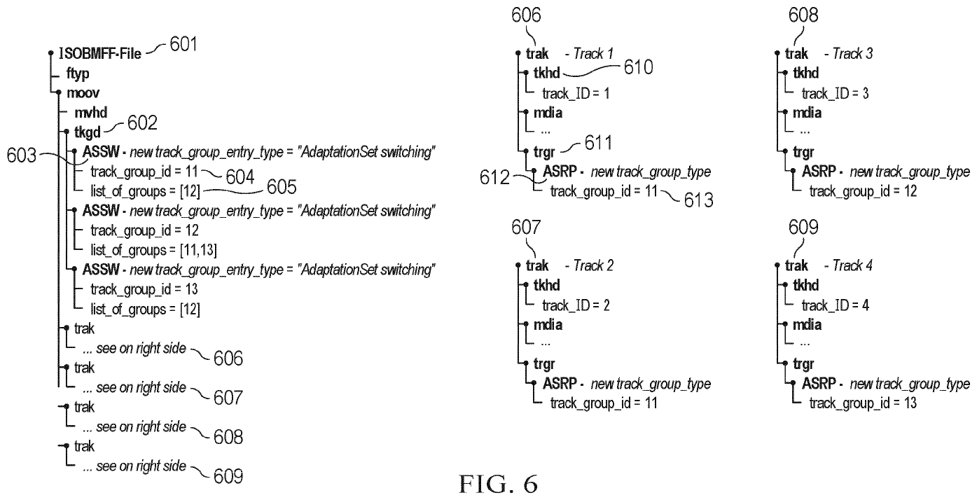

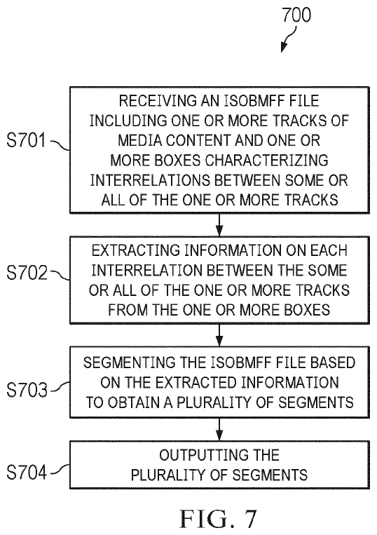

These interrelations between the some or all of the one or more tracks may be characterized in the ISOBMFF file, 301, by one or more boxes as illustrated in the example structures of FIGS. 3 to 6.

Notably, as used herein, the term “box” may generally be used to refer to, in some possible cases, an object-oriented building block defined by a unique (box) type identifier (and possibly also a respective length) for example as described in ISO 14496-12. Of course, the term “box” as used throughout the present disclosure shall not be understood to be limited to such specification only. Rather, the term “box” shall be generally understood as any suitable data structure or data container that may serve as a placeholder for data. Furthermore, as will also be understood and appreciated by the skilled person, such “box” may be referred to by using any other suitable term. An example may be that in some possible specifications (including the first definition of MP4), the “box” may alternatively be called an “atom” in certain cases. Further, the one or more boxes may, depending on various implementations and/or requirements, be of the same or different levels (or positions), nested (child/sub box vs. parent box), etc., as will be understood and appreciated by the skilled person.

In an embodiment, generating the ISOBMFF file, 301, may include grouping some or all of the one or more tracks into one or more track groups. Depending on the use case, these one or more track groups may correspond to one or more DASH AdaptationSets, 315, the one or more tracks within each track group may then correspond to one or more DASH Representations, 316, within the DASH AdaptationSet, 315. In an embodiment, these one or more track groups may correspond to one or more DASH AdaptationSets, 514, with the potentiality of switching playback from an identified source DASH AdaptationSet to a set of destination DASH AdaptationSets. Alternatively, these one or more track groups may correspond to one or more CMAF switching sets, 320, the one or more tracks within each track group may then correspond to one or more CMAF tracks within the CMAF switching set, 320.

In an embodiment, the ISOBMFF file, 301, 401, may include, for each of the one or more tracks within a track group, a track group type specific box, 309, 413, indicating the predefined and specific track group type and a track group identifier, 414. Tracks characterized with a same track group type and track group identifier may belong to a same track group, the track group type specific box, 309, 413, may be included in an ISOBMFF track group box, 306, 412.

A different grouping mechanism may also be applied. In an embodiment, the ISOBMFF file may include, for each of the one or more tracks within a track group, a grouping type specific box indicating the predefined and specific grouping type and a group identifier, wherein a grouping type specific box may be included in an ISOBMFF group list box.

In the case of one or more DASH AdaptationSets with the potentiality of switching, 514, the ISOBMFF file, 501, 601, may further include, for each of the switching potentialities, a track group entry box of predefined type, 510, 603, with its track group identifier, 604, being equal to the track group identifier of the track group identifying the source DASH AdaptationSet and a list of track group identifiers, 605, equal to those track group identifiers of the track groups identifying the destination DASH AdaptationSets.

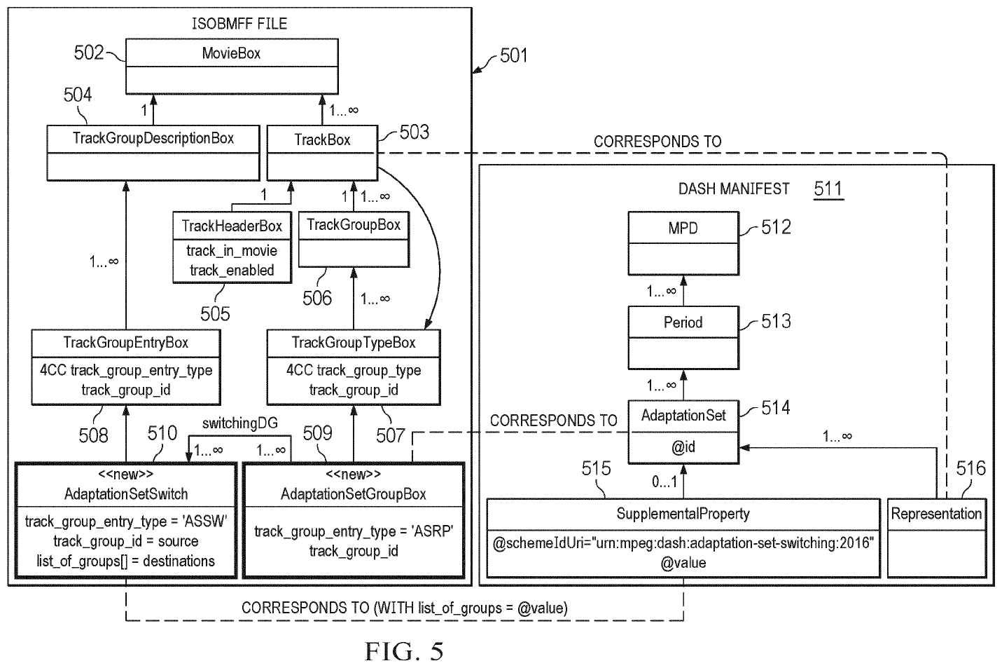

In other words, for example, a new type of track group for DASH AdaptationSets, 309, 509, may be created. For the purpose of collecting several tracks as Representations, 316, 516, into an AdaptationSet, 315, 514, a new track_group_type, 309, 509, may be defined, called merely explanatory in a non-binding manner an AdaptationSetGroup, 309, 509, for purposes of this document as illustrated in the example structure of FIGS. 3 and 5.

This AdaptationSetGroup, 309, 509, may be derived from a TrackGroupTypeBox, 307, 507, and identified by a 4CC-code. Requirements and semantics may further describe the purpose of this group.

A streaming packager may be able to read the AdaptationSetGroup, 309, 509, information, split the tracks from the file into separate segments according to this information and write the summary of all these individual segments into the streaming manifest, 311, 511.

For the case that a fully-multiplexed file reaches a player (of a client, for example), a mechanism may be needed to prevent the player from playing all contained tracks simultaneously. To disable a media player from playing all tracks of the Group instead of just one, either the track_in_movie or the track_enabled flags in the TrackHeaderBox, 305, 411, 505, may be cleared as necessary to select one default track to play.

Further use cases may make it necessary to not just build groups of tracks, but also to be able to group these groups themselves.

In an embodiment, generating the ISOBMFF file, 301, 501, may thus further include grouping the one or more track groups into one or more groups of track groups based on the side information. Each group of track groups may be indicative of an interrelation between the one or more track groups within the group of track groups.

In CMAF, 317, “Switching Sets”, 320, can be combined into “aligned switching sets”, 318, or “CMAF selection Sets”, 319. To represent aligned switching sets on ISOBMFF level, it may be necessary to build groups of groups, 310. In an embodiment, the one or more groups of track groups may thus correspond to one or more CMAF selection sets, 319. Alternatively, the one or more groups of track groups may correspond to one or more CMAF aligned switching sets, 318.

In an embodiment, the ISOBMFF file, 301, 401, may further comprise, for each of the one or more groups of track groups, a group of track groups specific box, 310, 404, including a list of references to track groups belonging to said group of track groups, 405. Each of the one or more group of track group specific boxes, 310, 404, may be instantiated by a predefined track group entry type of a track group entry box, 308, included in an ISOBMFF track group description box, 304, 402. Each of the one or more group of track group specific boxes, 310, 404, may indicate their individual track group identifier, 405, the track group identifier enabling referencing the group of track groups as track group.

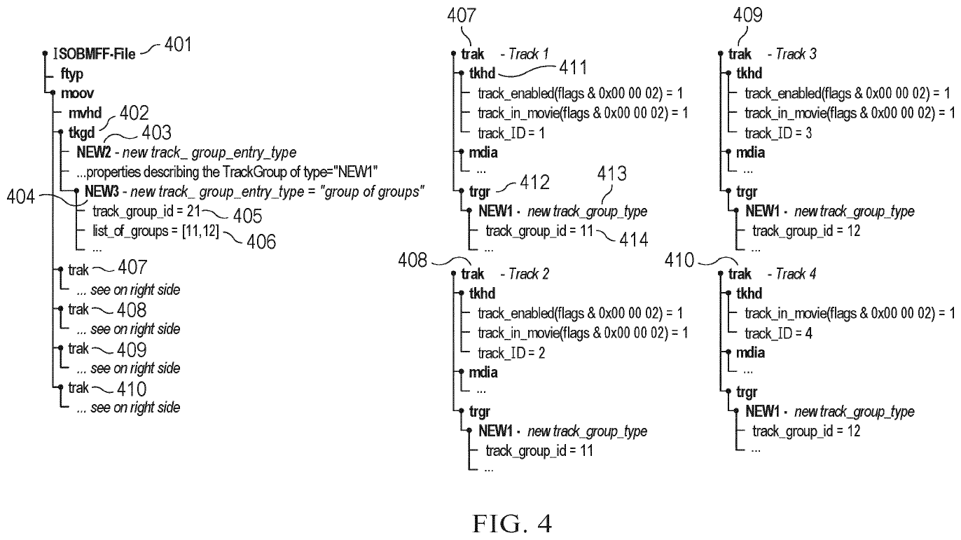

Using the AdaptationSetGroup concept as described above, may be accomplished by defining a new derivation of TrackGroupEntryBox, 308, 404, called in a mere explanatory and non-binding manner GroupOfGroups, 310, 404, for purposes of this document as illustrated in FIGS. 3 and 4. The new GroupOfGroups box, 310, 404, may carry a list of track_group_ids, 406. Each AdaptationSetGroup with an ID occurring in the list of track_group_ids may be part of the “group of groups”, 310, 404. This group of groups may signal an aligned switching set or selection set.

Referring to the examples of FIGS. 4 and 5, FIG. 4 illustrates an example with two

AdaptationSets, each consisting of two Representations. In the example of FIG. 4, the ISOBMFF file, 401, generated as described herein, contains 4 tracks:
Tracks 1, 407, and 2, 408, are grouped by a track_group_type=NEW1, 413, with track_group_id=11, 414.
Tracks 3, 409, and 4, 410, are grouped by a track_group_type=NEW1 with track_group_id=12.

This new track_group_type=“NEW1” indicates that this group shall be interpreted by a streaming packager to provide these tracks as different Representations in an AdaptationSet/Switching Set. A generated DASH manifest from the example above has the following structure (here: ids are set to match their respective counterparts in FIG. 4 for illustrative purpose):

Table 1 illustrates a DASH manifest (media presentation description, MPD) generated based on the information contained in/extracted from the ISOBMFF file illustrated in the example of FIG. 4.

TABLE 1

```
<MPD>
  <Period>
    <AdaptationSet id=“11” >
      <Representation id=“1” />
      <Representation id=“2” />
    </AdaptationSet>
    <AdaptationSet id=“12” >
      <Representation id=“3” />
      <Representation id=“4” />
    </Adaptation Set>
  </Period>
</MPD>
```

A new TrackGroupEntryType of “NEW2”, 403, in the TrackGroupDescriptionbox, 402, enhances this TrackGroup with additional properties. As example, all attributes and sub-elements of DASH AdaptationSets can be present here as simple fields or as child boxes which is not further detailed here.

Further in the example, a new track_group_entry_type=“NEW3”, 404, is shown with track_group_id=21, 405. This entry type is used to define a “group of groups”; in the example, it groups the track_group_id=11 with track_group_id=12 into a new group with track_group_id=21.

As described above, this group of groups may be a CMAF “selection set” or a CMAF “aligned switching set”, depending on the assigned track_group_entry_type.

FIG. 5 illustrates an example of DASH AdaptationSetSwitching as described herein. Table 2 illustrates a respective DASH manifest (media presentation description, MPD) generated based on the information contained in/extracted from the ISOBMFF file illustrated in the example of FIG. 5.

TABLE 2

```
<MPD>
  <Period>
    <AdaptationSet id=“11” >
      <SupplementalProperty schemeIdURI=“
      urn:mpeg:dash:adaptation-set-switching:2016”
value=“12” />
      <Representation id=“1” />
      <Representation id=“2” />
    </AdaptationSet>
    <AdaptationSet id=“12” >
      <SupplementalProperty schemeIdURI=“
      urn:mpeg:dash:adaptation-set-switching:2016”
value=“11,13” />
      <Representation id=“3” />
    </Adaptation Set>
    <AdaptationSet id=“13” >
      <SupplementalProperty schemeIdURI=“
      urn:mpeg:dash:adaptation-set-switching:2016”
value=“12” />
      <Representation id=“4” />
    </AdaptationSet>
  </Period>
</MPD>
```

### Switching Across AdaptationSets

Another application may be to use this mechanism for MPEG DASH “switching across Adaptation Sets” as per section 5.3.3.5 in ISO/IEC 23009-1:2019. MPEG DASH defines special SupplementalPropertyDescriptors (schemeIdUri=“urn: mpeg:dash:adaptation-set-switching: 2016”) to signal the possibility of seamlessly switching from one AdaptationSet (source) into another AdaptationSet (destination). In MPEG DASH, this is modelled as a directed graph, i.e. each AdaptationSet can have a distinct and different list of AdaptationSets that can be switched to.

Referring to the example of FIG. 5, for this use case, derivation of TrackGroupEntryBox, 508, called merely explanatory in a non-binding manner SwitchingDG for purposes of this document, may be defined as follows (similar to the GroupOfGroups box, 310, in FIG. 3): The AdaptationSetSwitchbox, 510, may be derived from the TrackGroupEntryBox, 308, and may carry a single track_group_id to identify the AdaptationSet it applies to, along with a list of track_group_ids. Each entry in that list may represent an AdaptationSet to which seamless switching is possible. This structure supplies all necessary information to write the special SupplementalPropertyDescriptor, 515, in the DASH manifest, 511.

### Switching Across Representations

A similar dependency mechanism is defined in MPEG DASH through the @dependencyId and @associationId attributes which defines dependencies between Representations (as per section 5.3.5 in ISO/IEC 23009-1:2019).

MPEG DASH defines dependent Representations (i.e. Representations that depend on other Representations) as “regular Representations except that they depend on a set of complementary Representations for decoding and/or presentation. “. Signaling is defined as” the @dependencyId contains the values of the @id attribute of all the complementary Representations, i.e. Representations that are necessary to present and/or decode the media content components contained in this dependent Representation.”. This can be modelled as a directed acyclic graph, i.e. each Representation can have a distinct and different list of Representations that it can be dependent on.

For this use case, another derivation of TrackGroupEntryBox, 308, called merely explanatory and in a non-binding manner DependencyDAG for purposes of this document, is defined as follows (similar to the GroupOfGroups box, 310): The DependencyDAG box may be derived from the TrackGroupEntryBox, 308, and may carry a single track_group_id to identify the track whose dependencies it lists, along with a list of track_group_ids which are the tracks. This structure supplies all necessary information to write the @dependencyId attribute in the DASH manifest.

MPEG DASH defines associated Representations as “Representations that provide information on their relationships with other Representations.”. This concept is very similar to dependent Representations and therefore can be modelled with a similar derivation of TrackGroupEntryBox, 308.

### Generalization of Group of Groups

This grouping may be defined either for a specific track_group_type only (i.e. the SwitchingSetGroup), or it may be generalized to group track_groups of any type. The type of the “group of groups” may either be explicitly specified by a type identifier (i.e. a track_group_entry_type), or implicitly given by the type of the member groups, or indicated by a to-be-defined element within the new GroupOfGroup Box. If this new “GroupOfGroup” Box carries its own track_group_id, further cascading may be possible.

Referring now to the example of FIG. 7, an example of a method, 700, of processing an ISO Base Media File Format, ISOBMFF, file is illustrated.

In step S701, a (single) ISOBMFF file is received (e.g., by a receiver, the receiver may be part of a segmenter), the ISOBMFF file including one or more tracks of media content and one or more boxes characterizing interrelations between some or all of the one or more tracks. In step S702, information on each interrelation between the some or all of the one or more tracks is extracted from the one or more boxes.

In step S703, the ISOBMFF file is segmented based on the extracted information to obtain a plurality of segments.

And in step S704 the plurality of segments is then output. The ISOBMFF segments may be output for transmission and/or streaming (e.g., over the Internet). For example, the ISOBMFF segments may be uploaded to a server, such as an origin server of a content delivery network (CDN), and/or provided to a multicasting server or broadcasting transmitter.

In an embodiment, the interrelations may be indicated by one or more track group boxes, grouping one or more tracks into a track group corresponding to a respective interrelation. As described above, the track group may correspond to a DASH AdaptationSet, the one or more tracks within the track group corresponding to one or more DASH Representations within the DASH adaptation set. In case of DASH AdaptationSets, the track group may correspond to a DASH AdaptationSet with the potentiality of switching playback from an identified source DASH AdaptationSet to a set of destination DASH AdaptationSets. Alternatively, the track group may correspond to a CMAF switching set, the one or more tracks within the track group corresponding to one or more CMAF tracks within the CMAF switching set.

In an embodiment, for each of the one or more tracks within the track group, the respective interrelation may be indicated by a track group type specific box indicating the predefined and specific track group type and a track group identifier. Tracks characterized with a same track group type and track group identifier may belong to a same track group, the track group type specific box being included in an ISOBMFF track group box.

In an embodiment, for each of the one or more tracks within a track group, the respective interrelation may be indicated by a grouping type specific box indicating the predefined and specific grouping type and a group identifier, wherein a grouping type specific box may be included in an ISOBMFF group list box.

In case of DASH Adaptation sets with switching potentiality, for each of the switching potentialities, the respective interrelation may further be indicated by a track group entry box of predefined type, with its track group identifier being equal to the track group identifier of the track group identifying the source DASH AdaptationSet and a list of track group identifiers equal to those track group identifiers of the track groups identifying the destination DASH AdaptationSets.

In an embodiment, the interrelations may further be indicated by grouping of the one or more track groups into one or more groups of track groups. Each group of track groups may be indicative of an interrelation between the one or more track groups within the group of track groups. In an embodiment, the group of track groups may correspond to a CMAF selection set. Alternatively, the group of track groups may correspond to a CMAF aligned switching set.

In an embodiment, the interrelations may be indicated by one or more group of track group specific boxes, each including a list of references to track groups belonging to said group of track groups. Each of the one or more group of track group specific boxes may be instantiated by a predefined track group entry type of a track group entry box included in an ISOBMFF track group description box. Each of the one or more group of track group specific boxes may indicate its individual track group identifier, the track group identifier enabling referencing the group of track groups as track group.

In an embodiment, the method may further include generating a manifest file based on the ISOBMFF file and outputting the manifest file alongside the plurality of segments. The manifest file may include the information on each interrelation between the some or all of the one or more tracks extracted from the one or more boxes. As described above and also illustrated in the example of FIG. 5, by generating the enhanced ISOBMFF file it is no longer necessary to signal additional side information for generating a manifest file. The manifest file may be a DASH media presentation description, MPD, file.

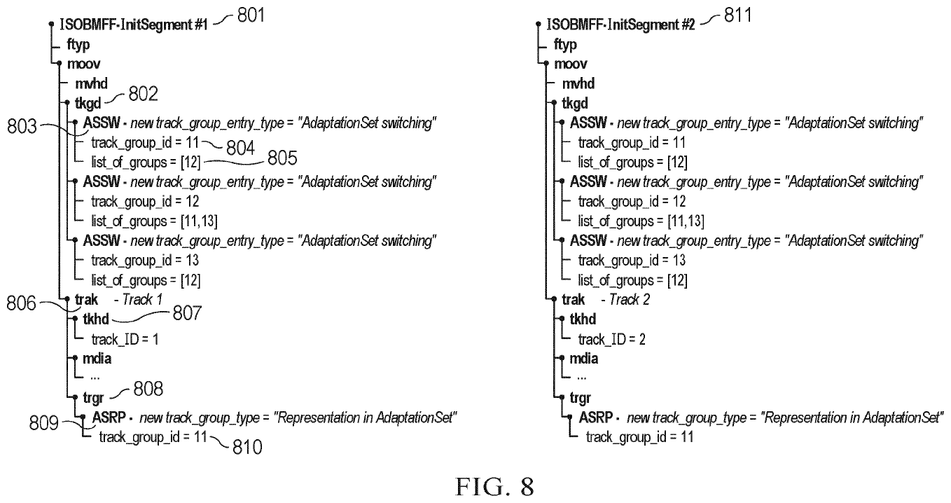

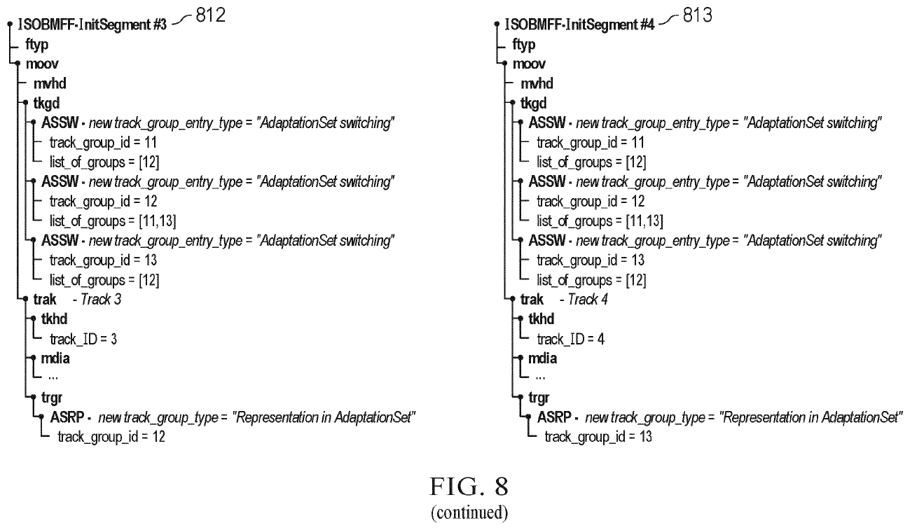

Referring to the example of FIG. 8, in an embodiment, the segmenting the ISOBMFF file may include generating one or more DASH initialization segments, 801, 811, 812, 813, the DASH initialization segments including the information on each interrelation between the some or all of the one or more tracks extracted from the one or more boxes, 802-810.

The DASH MPD file may include the information included in the DASH initialization segments. Alternatively, the DASH MPD file may include the information on each interrelation between the some or all of the one or more tracks based on the ISOBMFF file, but the DASH initialization segments exclude the interrelation information.

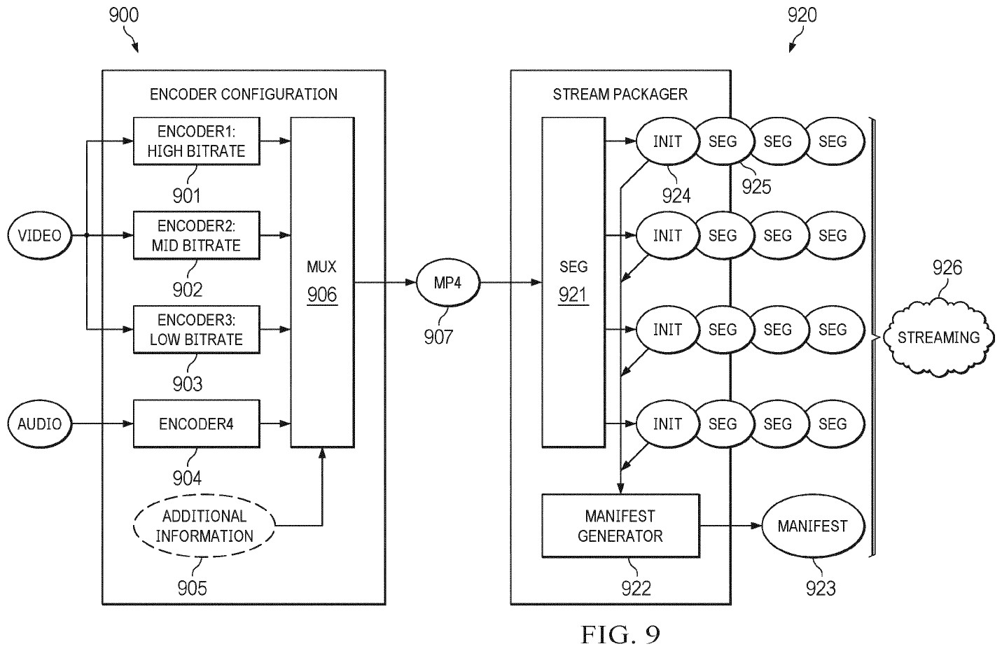

Referring to the example of FIG. 9, a system of an apparatus for processing media streams, 900, and an apparatus for processing an ISO Base Media File Format, ISOBMFF, file, 920, is illustrated.

The apparatus for processing media streams may be implemented, for example, as an encoder configuration, 900, comprising four encoders, 901, 902, 903 and 904 as well as a Multiplexer 906.

The apparatus for processing an ISO Base Media File Format, ISOBMFF, file may be implemented, for example, as a Stream Packager (streaming packager) 920 comprising a Segmenter 921 and a Manifest Generator 922.

The Multiplexer 906 receives one or more, in this case four, media streams from the encoders 901, 902, 903 and 904. The four media streams comprise (include) media content, that is video and audio, comprising (divided into) one or more tracks. The video content may be encoded at different bitrates, high, middle and low.

The Mulitplexer 906 further receives side information, 905, for the one or more media streams, the side information characterizing interrelations between some or all of the one or more tracks, and generates an ISO Base Media File Format, ISOBMFF, file (MP4) 907, based on the one or more media streams and the side information. The Multiplexer 906 outputs the generated ISOBMFF file for further processing by the Stream Packager, 920.

The Segmenter, 921, receives the ISOBMFF file, 907, including the one or more tracks of the media content and the one or more boxes characterizing the interrelations between some or all of the one or more tracks. The Segmenter, 921, extracts the information on each interrelation between the some or all of the one or more tracks from the one or more boxes and segments the ISOBMFF file, 907, based on the extracted information to obtain a plurality of segments, 924, 925. The plurality of segments may include initialization segments, 924, and media segments 925. The plurality of segments is output for streaming. For example, the plurality of segments 924, 925, may be output to a streaming server or provided to a multicasting server or broadcasting transmitter.

In the example of FIG. 9, a manifest file, 923, is further generated by a Manifest Generator, 922, based on the initialization segments, 924, and output alongside the plurality of segments, 924, 925, for streaming.

In case of a DASH MPD file, the DASH MPD file may include the information included in the DASH initialization segments. Alternatively, the DASH MPD file may include the information on each interrelation between the some or all of the one or more tracks based on the ISOBMFF file, but the DASH initialization segments exclude the interrelation information.

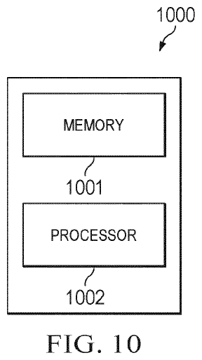

It is to be noted that the methods as described herein can also be implemented as a program comprising instructions that, when executed by a processor, cause the processor to carry out the method. FIG. 10 illustrates a respective example of a device, 1000, including memory, 1001, and a processor 1002. The program may be stored on a computer-readable storage medium. In other implementations, the device may have more than one processor.

A computing device implementing the techniques described above can have the following example architecture. Other architectures are possible, including architectures with more or fewer components. In some implementations, the example architecture includes one or more processors (e.g., dual-core Intel® Processors), one or more output devices (e.g., LCD), one or more network interfaces, one or more input devices (e.g., mouse, keyboard, touch-sensitive display) and one or more computer-readable mediums (e.g., RAM, ROM, SDRAM, hard disk, optical disk, flash memory, etc.). These components can exchange communications and data over one or more communication channels (e.g., buses), which can utilize various hardware and software for facilitating the transfer of data and control signals between components.

The term “computer-readable medium” refers to a medium that participates in providing instructions to processor for execution, including without limitation, non-volatile media (e.g., optical or magnetic disks), volatile media (e.g., memory) and transmission media.

Transmission media includes, without limitation, coaxial cables, copper wire and fiber optics. Computer-readable medium can further include operating system (e.g., a Linux® operating system), network communication module, audio interface manager, audio processing manager and live content distributor. Operating system can be multi-user, multiprocessing, multitasking, multithreading, real time, etc. Operating system performs basic tasks, including but not limited to: recognizing input from and providing output to network interfaces and/or devices; keeping track and managing files and directories on computer-readable mediums (e.g., memory or a storage device); controlling peripheral devices; and managing traffic on the one or more communication channels. Network communications module includes various components for establishing and maintaining network connections (e.g., software for implementing communication protocols, such as TCP/IP, HTTP, etc.).

Architecture can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user. The computer can have a touch surface input device (e.g., a touch screen) or a keyboard and a pointing device such as a mouse or a trackball by which the user can provide input to the computer. The computer can have a voice input device for receiving voice commands from the user.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Unless specifically stated otherwise, as apparent from the following discussions, it is appreciated that throughout the present disclosure discussions utilizing terms such as “processing”, “computing”, “calculating”, “determining”, “analyzing” or the like, refer to the action and/or processes of a computer or computing system, or similar electronic computing devices, that manipulate and/or transform data represented as physical, such as electronic, quantities into other data similarly represented as physical quantities.

Reference throughout this disclosure to “one example embodiment”, “some example embodiments” or “an example embodiment” means that a particular feature, structure or characteristic described in connection with the example embodiment is included in at least one example embodiment of the present disclosure. Thus, appearances of the phrases “in one example embodiment”, “in some example embodiments” or “in an example embodiment” in various places throughout this disclosure are not necessarily all referring to the same example embodiment. Furthermore, the particular features, structures or characteristics may be combined in any suitable manner, as would be apparent to one of ordinary skill in the art from this disclosure, in one or more example embodiments.

As used herein, unless otherwise specified the use of the ordinal adjectives “first”, “second”, “third”, etc., to describe a common object, merely indicate that different instances of like objects are being referred to and are not intended to imply that the objects so described must be in a given sequence, either temporally, spatially, in ranking, or in any other manner.

Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted”, “connected”, “supported”, and “coupled” and variations thereof are used broadly and encompass both direct and indirect mountings, connections, supports, and couplings.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

It should be appreciated that in the above description of example embodiments of the present disclosure, various features of the present disclosure are sometimes grouped together in a single example embodiment, Fig., or description thereof for the purpose of streamlining the present disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed example embodiment. Thus, the claims following the Description are hereby expressly incorporated into this Description, with each claim standing on its own as a separate example embodiment of this disclosure.

Furthermore, while some example embodiments described herein include some, but not other features included in other example embodiments, combinations of features of different example embodiments are meant to be within the scope of the present disclosure, and form different example embodiments, as would be understood by those skilled in the art. For example, in the following claims, any of the claimed example embodiments can be used in any combination.

In the description provided herein, numerous specific details are set forth. However, it is understood that example embodiments of the present disclosure may be practiced without these specific details. In other instances, well-known methods, structures and techniques have not been shown in detail in order not to obscure an understanding of this description.

Thus, while there has been described what are believed to be the best modes of the present disclosure, those skilled in the art will recognize that other and further modifications may be made thereto without departing from the spirit of the present disclosure, and it is intended to claim all such changes and modifications as fall within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

1. A method of processing media streams, the method including:
receiving one or more media streams and side information for the one or more media streams, the one or more media streams comprising media content comprising one or more tracks;
generating an ISO Base Media File Format, ISOBMFF, file based on the one or more media streams and the side information; and
outputting the generated ISOBMFF file for further processing.

2. The method of claim 1, wherein the side information is indicative of interrelations between some or all of the one or more tracks.

3. The method of claim 1, wherein generating the ISOBMFF file includes grouping some or all of the one or more tracks into one or more track groups.

4. The method of claim 3, wherein the one or more track groups correspond to one or more DASH AdaptationSets, the one or more tracks within each track group correspond to one or more DASH Representations within the DASH AdaptationSet.

5. The method of claim 4, wherein the one or more track groups correspond to one or more DASH AdaptationSets with the potentiality of switching playback from an identified source DASH AdaptationSet to a set of destination DASH AdaptationSets.

6. The method of claim 3, wherein the one or more track groups correspond to one or more CMAF switching sets, the one or more tracks within each track group correspond to one or more CMAF tracks within the CMAF switching set.

7. The method of claim 3, wherein the ISOBMFF file includes, for each of the one or more tracks within a track group, a track group type specific box indicating the predefined and specific track group type and a track group identifier, wherein tracks characterized with a same track group type and track group identifier belong to a same track group, the track group type specific box being included in an ISOBMFF track group box.

8. The method of claim 3, wherein the ISOBMFF file includes, for each of the one or more tracks within a track group, a grouping type specific box indicating the predefined and specific grouping type and a group identifier, wherein the grouping type specific box is included in an ISOBMFF group list box.

9. (canceled)

10. The method of claim 3, wherein generating the ISOBMFF file further includes grouping the one or more track groups into one or more groups of track groups based on the side information.

11. The method of claim 10, wherein each group of track groups is indicative of an interrelation between the one or more track groups within the group of track groups.

12-13. (canceled)

14. The method of claim 10, wherein the ISOBMFF file further includes, for each of the one or more groups of track groups, a group of track groups specific box including a list of references to track groups belonging to said group of track groups.

15. The method of claim 14, wherein each of the one or more group of track group specific boxes is instantiated by a predefined track group entry type of a track group entry box included in an ISOBMFF track group description box.

16-17. (canceled)

18. A method of processing an ISO Base Media File Format, ISOBMFF, file, the method including:
receiving an ISOBMFF file including one or more tracks of media content and one or more boxes characterizing interrelations between some or all of the one or more tracks;
extracting information on each interrelation between the some or all of the one or more tracks from the one or more boxes;
segmenting the ISOBMFF file based on the extracted information to obtain a plurality of segments; and
outputting the plurality of segments.

19. The method of claim 18, wherein the interrelations are indicated by one or more track group boxes, grouping one or more tracks into a track group corresponding to a respective interrelation.

20. The method of claim 19, wherein the track group corresponds to a DASH AdaptationSet, the one or more tracks within the track group corresponding to one or more DASH Representations within the DASH AdaptationSet.

21. The method of claim 20, wherein the track group corresponds to a DASH AdaptationSet with the potentiality of switching playback from an identified source DASH AdaptationSet to a set of destination DASH AdaptationSets.

22. The method of claim 19, wherein the track group corresponds to a CMAF switching set, the one or more tracks within the track group corresponding to one or more CMAF tracks within the CMAF switching set.

23. The method of any of claim 19, wherein, for each of the one or more tracks within a track group, the respective interrelation is indicated by a track group type specific box indicating the predefined and specific track group type and a track group identifier, wherein tracks characterized with a same track group type and track group identifier belong to a same track group, the track group type specific box being included in an ISOBMFF track group box.

24. The method of claim 19, wherein, for each of the one or more tracks within a track group, the respective interrelation is indicated by a grouping type specific box indicating the predefined and specific grouping type and a group identifier, wherein the grouping type specific box is included in an ISOBMFF group list box.

25. (canceled)

26. The method of claim 19, wherein the interrelations are further indicated by grouping of the one or more track groups into one or more groups of track groups.

27. The method of claim 26, wherein each group of track groups is indicative of an interrelation between the one or more track groups within the group of track groups.

28-29. (canceled)

30. The method of claim 26, wherein the interrelations are indicated by one or more group of track group specific boxes, each including a list of references to track groups belonging to said group of track groups.

31. The method of claim 30, wherein each of the one or more group of track group specific boxes is instantiated by a predefined track group entry type of a track group entry box included in an ISOBMFF track group description box.

32. The method of claim 30, wherein each of the one or more group of track group specific boxes indicates its individual track group identifier, the track group identifier enabling referencing the group of track groups as track group.

33-38. (canceled)

39. An apparatus for processing media streams, the apparatus including one or more processors configured to carry out a method including:
receiving one or more media streams and side information for the one or more media streams, the one or more media streams comprising media content comprising one or more tracks;
generating an ISO Base Media File Format, ISOBMFF, file based on the one or more media streams and the side information; and
outputting the generated ISOBMFF file for further processing.

40. The apparatus of claim 39, wherein the apparatus comprises a Multiplexer.

41. An apparatus for processing an ISO Base Media File Format, ISOBMFF, file, the apparatus including one or more processors configured to carry out a method including:
receiving an ISOBMFF file including one or more tracks of media content and one or more boxes characterizing interrelations between some or all of the one or more tracks;
extracting information on each interrelation between the some or all of the one or more tracks from the one or more boxes;
segmenting the ISOBMFF file based on the extracted information to obtain a plurality of segments; and
outputting the plurality of segments.

42-47. (canceled)
